(19) United States
(12) Patent Application Publication
(10) Pub. No.: US 2026/0060899 A1
(43) Pub. Date: Mar. 5, 2026

(54) Medicine dispensing devices and methods for dispensing medicine

(71) Applicant: VMI Holland B.V., Epe (NL)

(72) Inventor: Patrick van Voorn, Epe (NL)

(73) Assignee: VMI Holland B.V., Epe (NL)

(21) Appl. No.: 19/104,712

(22) PCT Filed: Sep. 14, 2023
(86) PCT No.: PCT/EP2023/075226

§ 371 Date: Feb. 19, 2025

(30) Foreign Application Priority Data
Sep. 16, 2022 (NL) 2033058

(51) Int. Cl. A61J 7/04; A61J 1/03

(52) U.S. Cl. CPC A61J 7/0481; A61J 1/03

(57) ABSTRACT

A method of dispensing discrete tablets from a feeder unit comprises the steps of a) determining a last allowable dispensing moment for the tablets from the feeder unit; b) comparing the last allowable dispensing moment to a scheduled dispensing time; and c) sending a dispense signal only if the scheduled dispensing time is before the last allowable dispensing moment.

### FIELD OF THE INVENTION

The disclosure relates to methods and systems for dispensing medicines, in particular into pouches.

### BACKGROUND

When dispensing medicines for individual and/or daily packaging, medicines are typically kept in cannisters for efficient dispensing from an automatic dispensing device. One such device is shown in US 2014/0366489 A1, which discloses a device for automatically dispensing solid substances for medical use. The device is provided with a great number of feeder units, also known as ‘canisters’, distributed in a radial grid about a rotation axis. Each cannister holds an amount of solid substances specific to that respective feeder unit. Hence, together, the cannisters can dispense a wide variety of solid substances. The cannisters dispense to a collection section, which then leads to a packing unit which packs the solid substances received from the collection trays in a foil that is sealed to form individually closed pockets, also known as ‘pouches’.

### SUMMARY

Medicines which cannot be dispensed from cannisters are typically hand-loaded into a plate, which is then loaded into an automatic dispensing device (such as the one of US 2014/0366489) where the medicines are routed to the collection section and then the packing unit. The need for the use of a plate can be due any number of reasons, for example, due to the medicine itself (e.g., fragile tablets), the infrequent need for the medicine, guidelines or regulations regarding the repackaging of tablets after removing from the initial packaging, or other reasons. Due to the manual labour involved, use of a plate results in an overall less efficient process than using feeder units (e.g., cannisters) for dispensing, and can be more error prone than an automatic process from a feeder unit. Thus, the methods and devices disclosed allow for more efficient dispensing and less manual work in the dispensing process, even when the allowable open air time (the time between removing from initial packaging and sealed in new packaging such as a pouch) is very short.

According to a first aspect, a method of dispensing discrete tablets from a feeder unit comprises the following steps: a) determining a last allowable dispensing moment for the tablets from the feeder unit; b) comparing the last allowable dispensing moment to a scheduled dispensing time; and c) sending a dispense signal only if the scheduled dispensing time is before the last allowable dispensing moment. Such a method allows for automatic dispensing of tablets (e.g., from a cannister) even when the allowable open air time for the tablets is very short. The last allowable dispensing moment is determined from adding the allowable open air time allowable for a specific tablet to the time which the original packaging was opened. Thus, this method is especially useful for tablets or medicines which have not been tested for open air time, and therefore only allowed a short open air time, for example, 24 or 48 hours. The open air time is typically determined through testing or through regulations/policies.

According to an embodiment, the method further comprises the following steps: d) comparing a known expiry date of the tablets with a pouch consumption date; and e) sending a dispense signal only if the known expiry date is after the pouch consumption date. The expiry date is typically provided by the tablet producer and can be entered manually or automatically (e.g., scanning a barcode) when the tablets are removed from the original packaging and placed into a cannister (or other feeder unit) for dispensing. Such steps ensure that the tablets will not be expired when they are to be consumed by the patient.

According to an embodiment, the method further comprises f) dispensing discrete tablets from the feeder unit only if dispense signals are received from steps c) and e). Such a method allows for automatic and therefore more efficient dispensing and packaging of many tablets which previously had to involve manual work (e.g., be manually loaded into a plate) due to short open air times, while ensuring that the tablets do not degrade during the production process (due to open air time) or expire before they are to be consumed from the package (e.g., pouch). Optionally, steps d) and e) are performed before steps a)-c). Alternatively, steps a)-c) are performed simultaneously with steps d)-e). The order of steps can be varied depending on systems, priorities and various requirements.

According to an embodiment, if step b) determines that the last allowable dispensing moment is before the scheduled dispensing time, a notification is sent that the feeder unit should be replaced with a second feeder unit which has a later last allowable dispensing moment. Optionally, the notification instructs an operator to prepare the second feeder unit with tablets of the same composition. The second feeder unit can then be delivered to the dispensing machine, where it can optionally replace the feeder unit for the production job. In some embodiments, the feeder unit can be left in the dispenser and simply assigned to anther production job which has an earlier schedule dispensing time.

According to an embodiment, if step b) determines that the last allowable dispensing moment is before the scheduled dispensing time, the method restarts with a second feeder unit which has a later last allowable dispensing moment. The second feeder unit could already be inside the dispenser, or in a storage position, where it can be moved (either manually or automatically) to a feeder position for use. This could be the position of the feeder unit (after it has been moved or removed) or another position. Optionally, the method further comprises removing the feeder unit.

According to an embodiment, if step d) determines that the known expiry date of the tablets is before the pouch consumption date, a notification is sent that the feeder unit should be replaced with a second feeder unit which has a later expiry date. This notification can indicate that an operator should prepare a new feeder unit, retrieve one from a storage position, or simply designate a new one which is already in a feeder position. Optionally, then the method restarts step d) with a second feeder unit which has a later expiry date. Such steps ensure that medication which is packaged and sent to a patient is not beyond its expiry date when it is to be consumed.

According to an embodiment, step a) involves determining the allowable open air time for the tablets in the feeder unit, and calculating the last allowable dispensing moment based on the moment the tablets were removed from an original packaging and the allowable open air time. Allowable open air time can be set based on past testing or on regulations. The determination can be made, for example, by looking up whether the specific tablet has a tested allowable open air time, and if it does to set that as the allowable open air time. If there is no tested allowable open air time, the system may determine that the open air time is set by a specific rule or regulation and apply that. For example, certain types or categories of tablets, if untested, may only have an open air time of 48 hours. The system may determine that the tablet is of the type in that category, and then apply the rule/regulation setting 24 hours as the allowable open air time. In further cases, for any tablets that cannot be determined to fit into any categories, a set (usually quite short, e.g., 24 hours) allowable open air time is determined to apply to those tablets. The last allowable dispensing moment is then determined as the time the original packaging was opened plus the allowable open air time, and typically set as a specific time on a specific date.

According to an embodiment, the dispensing device comprises a dispensing section and a collection section, and the feeder unit sits in one of a plurality of feeder positions in the dispensing section and dispenses the tablets to the collection section.

According to a further aspect, a dispensing device for dispensing discrete tablets comprises a dispensing section defining an array of feeder positions for holding a plurality of feeder units, and a control unit for controlling the dispensing process. The control unit is configured to perform the following steps a) determine a last allowable dispensing moment for the tablets from a first feeder unit; b) compare the last allowable dispensing moment to a scheduled dispensing time for a particular run job; and c) send a dispense signal to dispense the tablets from the first feeder unit only if the scheduled dispensing time is before the last allowable dispensing moment. Optionally, the control unit is further configured to perform the following steps: d) comparing a known expiry date of the tablets with a pouch consumption date for the particular run job; and e) sending a dispense signal to dispense the tablets from the first feeder unit only if the known expiry date is after the pouch consumption date. Such a dispensing device enables efficient dispensing of tablets into packages while ensuring that such tablets do not exceed an allowable open air time between being removed from the manufacturers packaging (to be put into the feeder unit) and sealed into a pouch. Optionally, the dispensing device can further comprise a collection section for receiving the tablets from the dispensing section, a packaging section for receiving the tablets from the collection section and packaging the tablets into pouches.

According to an embodiment, the control unit is further configured to commence dispensing tablets from the first feeder unit when dispense signals are received from steps c) and e). By waiting for dispense signals to ensure that the production job can be completed with tablets that will not exceed their specific allowable open air time or expire before they are scheduled to be consumed, the dispenser ensures a quality product with an efficient packaging process. Optionally, the control unit is configured to request a second feeder unit for the particular run job if the comparing step b) determines that the last allowable dispensing moment is after the scheduled dispensing time for the particular run job.

### SHORT DESCRIPTION OF DRAWINGS

The present invention will be discussed in more detail below, with reference to the attached drawings, in which

FIG. 1A shows a front view of an automated dispensing device for forming a plurality of medicament packages containing discrete medicaments dispensed and packaged by said automated dispensing device;

FIG. 1B shows a top view of the device of FIG. 1A;

FIG. 2 shows schematic view of a process for dispensing and packaging medicines.

### DESCRIPTION OF EMBODIMENTS

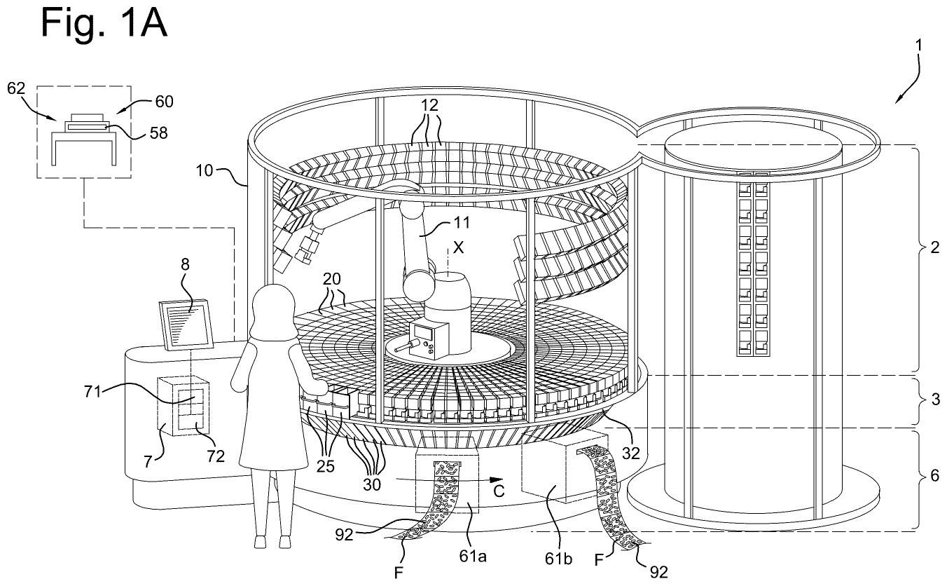

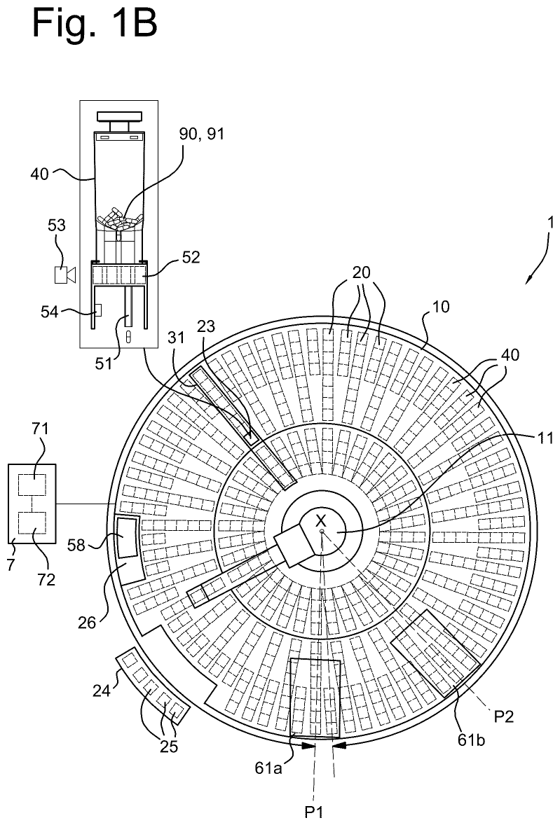

FIG. 1A shows a dispensing device 1 for dispensing solid items, articles or substances 90 for medical use, e.g., pharmaceuticals, pills, tablets, capsules or the like; and will hereinafter simply be referred to as tablets. FIG. 1B shows a top view of the dispensing device 1.

The dispensing device 1 comprises a dispensing section 2 for dispensing the solid substances 90, a collection section 3 for collecting the tablets 90 from the dispensing section 2 and a packaging section 6 for packing the tablets 90. The collection section 3 is located below or vertically below the dispensing section 2. The packaging section 6 is located below or vertically below the collection section 3. The dispensing device 1 further comprises a housing 10 for shielding the aforementioned sections 2, 3, 6 from unauthorized access.

The dispensing section 2 defines an array of holding positions 20 for holding a plurality of cannisters 40, tablet cases or other type of feeder unit. Each holding position comprises a docking member for mating with or receiving a respective one of the cannisters 40, with an appropriate aperture or channel to allow passage of dispensed tablets 90 through the holding position 20 into the collection section 3 underneath. In this example, the array of holding positions 20 is distributed circumferentially about a rotation axis X. More in particular, the array of holding positions 20 is distributed circumferentially or according to a radial grid, e.g., in a plurality of radially extending rows arranged side-by-side or adjacent in a circumferential direction about the rotation axis X. Preferably, the housing 10 extends cylindrically around the array of holding positions 20. In this example, the circumferential walls of the housing 10 are provided with a plurality of stock positions 12 for holding unused or auxiliary cannisters 40.

The dispensing device 1 is further provided with a robotic manipulator 11, which can include a robot arm, for automatic, automated or autonomous handling, positioning, removing and/or repositioning the cannisters 40 with respect to the array of holding positions 20. The robotic manipulator 11 is provided with a gripper head, known per se, to pick-and-place the cannisters 40. In this embodiment, the robotic manipulator 11 is located at the center of the array of holding positions 20, close to, at or near the rotation axis X. In said position, all holding positions 20 and stock positions 10 are typically within reach of the robotic manipulator 11.

Each cannister 40 typically comprises a container for holding an amount of tablets 90 with a composition 91 specific to said respective cannister 40. The term ‘composition’ is to be interpreted as the chemical composition of the tablet 90, e.g., combination of ingredients, though could include slight variations. Each cannister 40 typically only holds tablets 90 of a single composition. The cannister 40 has a volume that may hold several hundreds or more (or less) of the tablets 90, depending on their size and shape.

Each cannister 40 further comprises an outlet 51, e.g., a fall pipe, for dispensing the tablets 90 towards the collection section 3 and a dispensing mechanism 52 between the container and the outlet 51 for controlled feeding of the solid substances 90 from the container into the outlet 51. In this embodiment, the dispensing mechanism 52 comprises a wheel that acts as a revolving door to singulate and feed the tablets 90 one by one towards the outlet 51. It will be apparent to one skilled in the art that alternative dispensing mechanisms may be provided which can singulate the tablets 90.

Each cannister 40 may further be provided with one or more sensors 53, 54, e.g., a vision camera, a photosensor, a laser sensor, a level sensor, a weight sensor or the like, for verifying the type, composition and/or integrity of the tablets 90, and for counting the amount of tablets 90 that have been dispensed.

As best seen in FIG. 1B, the dispensing section 2 further comprises a cannister loading member 24 with a plurality of cannister positions 25 for receiving new cannisters 40 into the dispensing device 1 and/or for removing cannisters 40 from the dispensing device 1. In this example, the cannister loading member 24 is formed as a drawer. Alternatively, a door or the like may be used.

The dispensing section 2 may also comprise a manual loading position 26 for receiving a medicine transport plate 58, that is manually loaded with tablets 90. This can be for a number of reasons, including but not limited to the medicines being unsuitable to be dispensed automatically with the aforementioned cannisters 40, medicines being used infrequently, and regulations regarding dispensing certain medications.

Plate 58 is loaded at plate filling station 60 (see FIG. 1A), which can be connected to dispensing device 1, or can be located remote from dispensing device. Plate filling station 60 comprises a docking station 62 for receiving and filling plates 58, similar to that described in US Pat. App. Pub. No. 2022/0192926, titled “Docking station and method for loading a medicine transport plate”, filed Mar. 9, 2022, which is hereby incorporated by reference.

The docking station 62 is typically hand-loaded by a technician, who is guided as to what medicines and how much to place in each compartment, and once loaded and checked, a plate 58 can be inserted, and then the tablets can be released from the docking station into the plate 58. The guidance and/or direction can be provided by control unit 7 and user interface 8 (of dispensing device 1), and/or another control unit system specific to the plate filling station 60. Once plate 58 has been loaded, the operator is instructed to bring the plate to the manual loading position 26, where it is loaded into the dispensing device 1 for dispensing into the collection section 3 and then the packaging section 6, where it is eventually sealed into pouches 92. Optionally, more than one plate 58 is first filled and then a certain number of plates (e.g., 5 plates) are transported from the plate filling station 60 to the dispensing device 1 together. Optional components, such as a robot, palate and/or conveyor can assist in the transport.

As further shown in FIG. 1A, the collection section 3 comprises a plurality of collection units, which can be trays or collection hoppers 30 which are open at a side facing the dispensing section 2 to receive selectively dispensed tablets 90 from one or more of the cannisters 40. In this example, each collection hopper 30 extends underneath a plurality of cannisters 40 at the same time to receive the tablets 90 from any of those cannisters 40. Each collection hopper 30 tapers towards the bottom and is provided, at said bottom, with a valve (not shown) that can be operated to drop the collected tablets 90 into the packaging section 6.

In this exemplary embodiment, the plurality of collection hoppers 30 are distributed circumferentially about the rotation axis X. More in particular, the plurality of collection hoppers 30 are held in a collection frame 32 that is rotatable about said rotation axis X to rotate the plurality of collection hoppers 30 relative to the array of holding positions 20 in the dispensing section 2. The rotation may be a stepped rotation, wherein each step aligns the plurality of collection hoppers 30 with a next group of cannisters 40 (or plate 58) in the array of holding positions 20. Each collection hopper 30 extends radially along a row of radially arranged holding positions 20.

The packaging section 6 comprises a first packaging unit 61a at a first angular packing position P1 about the rotation axis X. Optionally, the packaging section 6 may comprise a second packaging unit 61b at a second angular packing position P2 to increase the packing efficiency of the dispensing device 1. The valves of the collection hoppers 30 are operated when a respective one of the collection hoppers 30 is in a position overhead or directly above a selected one of the packaging units 61 to drop the collected tablets 90 into the respective packaging unit 61a, 61b. Each packaging unit 61a, 61b comprises a stock member for holding the packaging material, in this example a foil, a printer for printing information about the tablets 90 on the foil, a filling member for positioning the foil to receive the tablets 90, a seal member for forming a pouch around the received tablets 90, a perforation member for providing the foil with perforations between subsequently formed pouches and an output member for outputting the packaged tablets F from the dispensing device 1. Alternatively, one of the packaging units 61a, 61b or both may be arranged for packaging the tablets 90 in a storage material other than a foil, e.g., in vials or bottles.

As shown in FIGS. 1A-1B, the dispensing device 1 is further provided with a control unit 7 that is operationally and/or electronically connected with the robotic manipulator 11, the cannisters 40, the plate filling station 60, the packaging units 61a, 61b and other electronic equipment such as drives, sensors and the like, to control the operation of the dispensing device 1. The control unit 7 comprises a special purpose processor 71 and a computer-readable medium 72 holding computer-readable code or instructions that, when executed by the processor 71, cause the dispensing device 1 to operate according to the methods described in more detail hereafter. The computer-readable medium 72 is non-transitory or tangible, e.g. a physical data carrier such as a hard-drive, a USB-drive, a RAM memory or the like.

The dispensing device 1 may further be provided with a graphical user interface 8, for example, a screen, to provide a human operator with useful information about the dispensing, collection, inspection/correction and packing operation. Plate filling station 60 may have a separate control unit and/or user interface, or may share the control unit and user interface 8 with dispensing device 1.

A dispensing process typically involves the control unit 7 (or other control system) planning a production job based on orders received and tablets available in cannisters 40. When an order involves a tablet not in a cannister, control unit 7 can determine whether the tablets could be dispensed by a cannister or whether they cannot for some reason. For example, if there is simply no cannister already filled but there is no reason the tablets could not be dispensed by a cannister 40, control unit 7 can instruct an operator to prepare a cannister with that type of tablet. Such a filling process can be at a cannister filling location, store room or other location; and typically involves removing the tablets from their original packaging (e.g., sealed container, blister pack or other package which the producer or manufacturer seals the tablets within); and registering information about the tablets in the control system. Such information can include, but is not limited to: the type of tablet in the specific cannister, the expiry date of the tablet provided by the producer, and the latest allowable dispensing moment (e.g., day+hour) based on the open air time.

Open air time is the time between when the tablets are removed from the original packaging and when the tablets are resealed into a pouch (or other packaging) during the dispensing and packaging operation. Typically, this open air time involves the time which the tablets are in a plate 58 or in a cannister 40. The registration of information can be manual, or can be simply from scanning a barcode which includes the information and can register it with the control unit 7. The allowable open air time for specific tablets can also be stored in a database, where the control unit 7 looks up the allowable open air time for the specific type of tablet being registered. This is typically based on past tests, for example, tests by the producer of how long tablets can be exposed to open air before starting to degrade. If the tablets have not been subject to tests, regulations and/or policies usually set the allowable open air time as very short, e.g., 24 or 48 hours. The database can also include allowable open air times for specific types of tablets, and allowable open air time for all the rest which have not been tested and do not fit into enumerated categories (e.g., based on regulations, rules and/or policies). The filled cannister 40 is the loaded into a cannister position 25 as previously described for use in the dispensing device 1.

Any medicines which cannot be dispensed by a cannister (e.g., the tablets are too fragile or odd shaped for dispensing through a cannister) must be prepared by manually filling a plate. The control unit 7 can guide the operator in preparing the plate 58 at plate filling station 60, and then loading into manual loading position 26 as described above. Once all cannisters 40 and plates 58 have been loaded, a production job is run and all pouches 92 are produced, inspected (corrected if needed) and then typically sent to a dispatch area (not shown).

Typically, production jobs are planned for efficiency, which involves reducing the amount of plates 58 required for a job, and using cannisters 40 as much as possible (which can more quickly dispense tablets). As mentioned above, plates 58 are used for tablets which are not suitable for automatic dispensing from cannisters (e.g., they are too fragile for automatic dispensing), but also for other reasons such as infrequent use and (short) allowable open air time rules or regulations.

In some regulatory schemes, tablets may only be dispensed through cannisters 40 (or other dispensing containers containing medicines for multiple pouches 92) if an allowable open air time period has been determined through testing. In such regulatory schemes, in past systems when the allowable open air time has not been determined, the medicines had to be dispensed through first loading into a plate 58, and then loading the plate 58 into the dispending device 1 for packaging into pouches 92. This was a labour intensive practice, which slowed down a production job and increased the chances for error due to more manual work involved.

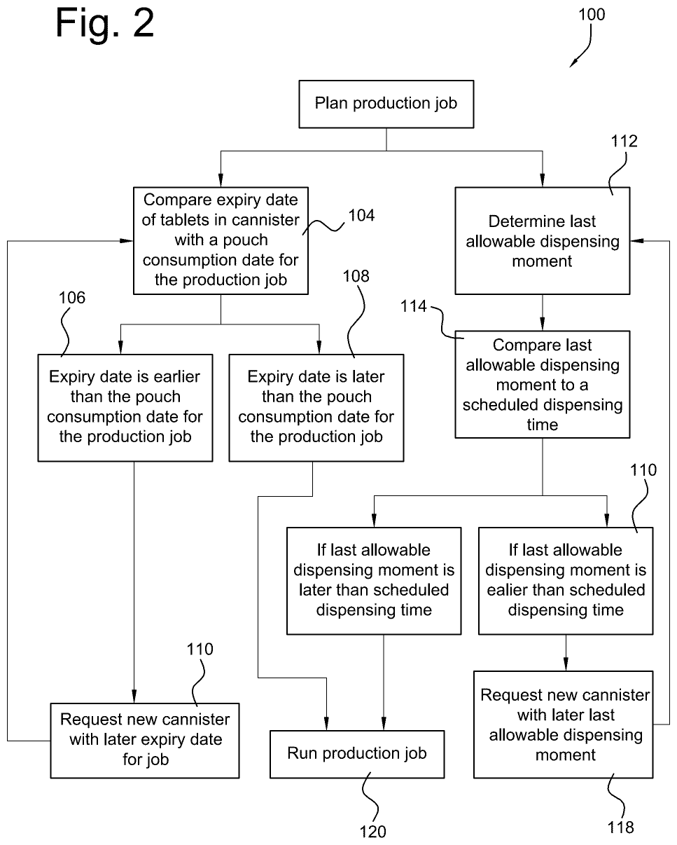

In the current system, such tablets can be automatically dispensed through cannisters 40 while still ensuring that the tablets do not exceed their allowable open air time, even if very short (e.g., 24 hours). Such a system involves the method 100 shown and described with respect to FIG. 2.

Method 100 of dispensing tablets 90 from cannister 40 includes two main branches, which can be performed simultaneously or one by one. In some embodiments, only one branch would be performed. One branch, starting with step 104 involves comparing an expiry date of tablets in a cannister with a pouch consumption date for the production job. The expiry date of the tablets is typically provided by the producer of the tablets, and that information is associated with the specific cannister when the canister is filled (either manually input or automatically, e.g., through scanning a barcode, as described above). The pouch consumption date is associated with the order(s) making up the production job, and refers to the date on which the tablets in a specific pouch are to be consumed by the patient.

Steps 106 and 108 relate to the outcomes of comparison step 104. In step 106, if the expiry date is earlier than the pouch consumption date for the production job, a new cannister is requested. This can either be a different cannister 40 which has a later expiration date already in the dispensing device 1; or the operator could be requested to fill a new cannister 40 with tablets with a later expiration date (later than the pouch consumption date) and deliver the new cannister to the dispensing device 1 as discussed above. Then the comparison step is redone. If the expiry date is later than the pouch consumption date for the production job, step 108 sends a dispense signal to run the production job.

The second branch, starting with step 112, is related to the allowable open air time for the specific tablet. As previously discussed, producers often test certain medications for the allowable open air time, the time at which the tablets must be sealed into pouches or discarded after removing from the producer's packaging, and provide this information with the tablets. For medications which have not been tested, this time limit can be set by policies, rules and/or regulations, and is typically very short, for example 24 or 48 hours. Thus, when tablets are being removed from their original packaging to fill a cannister 40, the last allowable dispensing time, typically in day and hour, is determined by taking a known or set allowable open air time, and adding that to the date and time at which the original packaging was opened (which is typically the same time the cannister 40 is filled). This is then associated with the specific cannister 40 (manually or automatically) and registered with the control unit 7.

Step 114 compares the last allowable dispensing moment to a scheduled dispensing time for the production job, which is the time the tablet will be dispensed if the production job is run. Step 116 shows the flow if the last allowable dispensing moment is earlier than the scheduled dispensing time under the production job, sending a request for a new cannister with a later last allowable dispensing moment at step 118. This can either be a different cannister 40 which has a later allowable dispensing time already in the dispensing device 1 or prepared and in a storage position; or the operator could be requested to fill a new cannister 40 with tablets and therefore having a later last allowable dispensing moment, and deliver to the dispensing device 1 as discussed above. Then the determining and comparison steps are redone. If the last allowable dispensing moment is later than the scheduled dispensing time for the production job, step 120 sends a dispense signal to run the production job.

When both branches send a dispense signal to run the production job, step 122 actually runs the production job, with the dispenser 1 dispensing the tablets into pouches. Such a method ensures that the tablets which are dispensed into the pouches in the production job will not expire before they are to be consumed by the patient, and have not exceeded their allowable open air time after being moved from the producer's packaging to the cannister before being sealed into the pouches. Thus, the method 100 shown and described makes it possible to use cannisters 40 for more efficient production even when medications are untested and/or have short allowable open air time. When the allowable open air time has been exceeded, the cannister 40 can be removed from the dispensing device 1, and can be replaced by a freshly filled cannister.

Method 100 allows for overall more efficient dispensing of tablets from cannisters in a dispensing device 1 while ensuring that the medicines are only dispensed to pouches where they will be consumed before their expiration date, and that the tablets do not exceed their specific allowable open air time (between being removed from their original packaging and being sealed in a pouch) in the process. Thus, method 100 saves time in packaging tablets 90, and is very useful particularly in situations where there are strict regulations or policies regarding allowable open air time, allowing for use of cannisters 40 and therefore automatic dispensing for more types of tablets than past systems, even when allowable open air time is very short (and in past systems therefore had to be dispensed using a plate 58). Additionally, dispensing through cannisters 40 can reduce errors by reducing the amount of manual work (e.g., manually filling at plate filling station 60 to use a plate 58).

While the method is described with respect to sending signals to run the production job, it could be implemented in the opposite fashion, for example, where signals are sent to stop the production job if the expiry date is found to be earlier than the pouch consumption date and/or the last allowable dispensing moment is earlier than the scheduled dispensing time. In addition steps may be ordered differently, for example, first having the comparison of the last allowable dispensing moment with the scheduled dispensing time and then doing the steps comparing the expiry date with pouch consumption date. Some methods would not include the expiry date and pouch consumption date comparisons where not needed.

The system can be formed of any combination of hardware and software, for example at least one special purpose processor and at least one non-transitory memory including computer program code, the at least one memory and the computer program code configured to, with the at least one processor, perform the above described processes. Any combination of one or more computer readable medium(s) may be utilized as memory. The computer readable medium may be a computer readable signal medium or a non-transitory computer readable storage medium. A non-transitory computer readable storage medium does not include propagating signals and may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. One or more computers and/or other control units may be present as part of the system, physically, or connected remotely.

The present invention has been described above with reference to a number of exemplary embodiments as shown in the drawings. Modifications and alternative implementations of some parts or elements are possible, and are included in the scope of protection as defined in the appended claims.

1. A method of dispensing discrete tablets from a feeder unit, the method comprising the following steps:
a) determining a last allowable dispensing moment for the tablets from the feeder unit;
b) comparing the last allowable dispensing moment to a scheduled dispensing time; and
c) sending a dispense signal only if the scheduled dispensing time is before the last allowable dispensing moment.

2. The method of claim 1, and further comprising the following steps:
d) comparing a known expiry date of the tablets with a pouch consumption date; and
e) sending a dispense signal only if the known expiry date is after the pouch consumption date.

3. The method of claim 2, and further comprising:
f) dispensing discrete tablets from the feeder unit only if dispense signals are received from steps c) and e).

4. The method of claim 2, wherein steps d) and e) are performed before steps a)-c).

5. The method of claim 2, wherein steps a)-c) are performed simultaneously with steps d)-e).

6. The method of claim 1, wherein if step b) determines that the last allowable dispensing moment is before the scheduled dispensing time, a notification is sent that the feeder unit should be replaced with a second feeder unit which has a later last allowable dispensing moment.

7. The method according to claim 6, wherein the notification instructs an operator to prepare the second feeder unit with tablets of the same composition.

8. The method of claim 1, wherein if step b) determines that the last allowable dispensing moment is before the scheduled dispensing time, the method restarts with a second feeder unit which has a later last allowable dispensing moment.

9. The method of claim 8, wherein the method further comprises removing the feeder unit and/or moving the second feeder unit into the previous position of the feeder unit.

10. (canceled)

11. The method of claim 1, wherein if step d) determines that the known expiry date of the tablets is before the pouch consumption date, a notification is sent that the feeder unit should be replaced with a second feeder unit which has a later expiry date.

12. The method of claim 1, wherein if step d) determines that the known expiry date of the tablets is before the pouch consumption date, the method restarts step d) with a second feeder unit which has a later expiry date.

13. The method of claim 1, wherein step a) involves determining the allowable open air time for the tablets in the feeder unit, and calculating the last allowable dispensing moment based on the moment the tablets were removed from an original packaging and the allowable open air time.

14. The method of claim 13, wherein the allowable open air time is a set time based on past testing.

15. The method of claim 13, wherein the allowable open air time is a set time based on regulation.

16. The method of claim 1, wherein the dispensing device comprises a dispensing section and a collection section, and the feeder unit sits in one of a plurality of feeder positions in the dispensing section and dispenses the tablets to the collection section.

17. A dispensing device for dispensing discrete tablets, the dispensing device comprising:
a dispensing section defining an array of feeder positions for holding a plurality of feeder units, and
a control unit for controlling the dispensing process, and configured to perform the following steps:
a) determining a last allowable dispensing moment for the tablets from a first feeder unit;
b) comparing the last allowable dispensing moment to a scheduled dispensing time for a particular run job; and
c) sending a dispense signal to dispense the tablets from the first feeder unit only if the scheduled dispensing time is before the last allowable dispensing moment.

18. The dispensing device of claim 17, wherein the control unit is further configured to perform the following steps:
d) comparing a known expiry date of the tablets with a pouch consumption date for the particular run job; and
e) sending a dispense signal to dispense the tablets from the first feeder unit only if the known expiry date is after the pouch consumption date.

19. The dispensing device of claim 18, wherein the control unit is further configured to commence dispensing tablets from the first feeder unit when dispense signals are received from steps c) and e).

20. The dispensing device of claim 17, wherein the control unit is configured to request a second feeder unit for the particular run job if the comparing step b) determines that the last allowable dispensing moment is after the scheduled dispensing time for the particular run job.

21. The dispensing device of claim 17, wherein the dispensing device further comprises: a collection section for receiving the tablets from the dispensing section, and
a packaging section for receiving the tablets from the collection section and packaging the tablets into pouches.
